(19) United States
(12) Patent Application Publication
(10) Pub. No.: US 2014/0139808 A1
(43) Pub. Date: May 22, 2014

(54) PROJECTION DEVICE FOR INCREASING LIGHT-TRANSMITTING EFFICIENCY

(71) Applicant: AZUREWAVE TECHNOLOGIES, INC., New Taipei City (TW)

(72) Inventors: CHENG-JUNG CHUNG, NEW TAIPEI CITY (TW); SHENG-CHUN HSU, NEW TAIPEI CITY (TW); CHUN-HSIANG WANG, NEW TAIPEI CITY (TW); LU-HSING LIAO, TAIPEI CITY (TW)

(73) Assignee: AZUREWAVE TECHNOLOGIES, INC., NEW TAIPEI CITY (TW)

(21) Appl. No.: 13/740,308

(22) Filed: Jan. 14, 2013

(30) Foreign Application Priority Data
Nov. 16, 2012 (TW) 101222255

(51) Int. Cl. G03B 21/14

(52) U.S. Cl. CPC G03B 21/14
USPC 353/20; 353/31

(57) ABSTRACT

A projection device for increasing light-transmitting efficiency includes a light-emitting unit, a light-guiding unit, an image display module and an image projection unit. The light-emitting unit includes a first light-emitting module for generating a first predetermined light source, a second light-emitting module for generating a second predetermined light source, and a third light-emitting module for generating a third predetermined light source. The light-guiding unit includes at least one photonic crystal fiber structure having a first light input terminal for receiving the first predetermined light source, a second light input terminal for receiving the second predetermined light source, a third light input terminal for receiving the third predetermined light source, and a light output terminal. The image display module is corresponding and adjacent to the light output terminal. The image projection unit includes at least one projection lens corresponding and adjacent to the image display module.

### BACKGROUND OF THE INVENTION

1. Field of the Invention

The instant disclosure relates to a projection device, and more particularly to a projection device for increasing light-transmitting efficiency.

2. Description of Related Art

According to the advancement in optical and the projection display technology, digital projection devices with high pixel resolution are widely employed for briefings, meetings, conferences or trainings. They are also becoming popular for family entertainment. Potential consumers look for lightweight digital projection apparatuses with high image quality and brightness at reasonable prices.

A projector is an apparatus that projects images onto an external screen by optical projection. A projector can be classified into four categories: CRT projector, liquid crystal display (LCD) projector, digital light processing (DLP) projector, and liquid crystal on silicon (LCOS) projector, basing on the type of light valve onboard. Moreover, the LCD projector is a transmission type projector because the onboard LCD panel is pervious to light. The LCOS and the DLP projectors are reflection type projectors because their image formation bases on light reflection principles.

The LCOS projector and the LCD projector are based on similar principles. However, unlike the LCD projector in which the light source is mounted behind the LCD panel and light signals pass through the LCD panel, the LCOS projector modulates light signals emitted from a light source to a screen by an LCOS panel. In fabricating the LCOS panel, CMOS wafer is adopted as a circuit substrate and a reflection layer. Following that, a liquid crystal layer is coated and packed with a glass panel. Due to the reflective structure in the LCOS projector, light signal emitted from the light source is reflected instead of passing through the LCOS panel. Thus, the LCOS projector is a reflective projector, whereas the LCD projector is a transmissive projector. However, the light-transmitting efficiency of the projector of the prior art is not good enough.

### SUMMARY OF THE INVENTION

One of the embodiments of the instant disclosure provides a projection device for increasing light-transmitting efficiency, comprising: a light-emitting unit, a light-guiding unit, an image display unit and an image projection unit. The light-emitting unit includes a first light-emitting module for generating a first predetermined light source, a second light-emitting module for generating a second predetermined light source, and a third light-emitting module for generating a third predetermined light source. The light-guiding unit includes at least one photonic crystal fiber structure, wherein the at least one photonic crystal fiber structure has a first light input terminal corresponding and adjacent to the first light-emitting module for receiving the first predetermined light source, a second light input terminal corresponding and adjacent to the second light-emitting module for receiving the second predetermined light source, a third light input terminal corresponding and adjacent to the third light-emitting module for receiving the third predetermined light source, and a light output terminal, and the first light input terminal, the second light input terminal and the third light input terminal are separated from each other. The image display unit includes at least one image display panel corresponding and adjacent to the light output terminal. The image projection unit includes at least one projection lens corresponding and adjacent to the at least one image display panel. Therefore, the first predetermined light source, the second predetermined light source and the third predetermined light source concurrently pass through the at least one photonic crystal fiber structure to form a mixed surface light source that is projected onto the at least one image display panel from the light output terminal, the surface light source is reflected by the at least one image display panel to form an image light source that is projected onto the at least one projection lens, and the image light source passes through the at least one projection lens to form an image projection light source.

Another one of the embodiments of the instant disclosure provides a projection device for increasing light-transmitting efficiency, comprising: a light-emitting unit, a light-guiding unit, a prism unit, an image display unit and an image projection unit. The light-emitting unit includes a first light-emitting module for generating a first predetermined light source, a second light-emitting module for generating a second predetermined light source, and a third light-emitting module for generating a third predetermined light source. The light-guiding unit includes at least one photonic crystal fiber structure, wherein the at least one photonic crystal fiber structure has a first light input terminal corresponding and adjacent to the first light-emitting module for receiving the first predetermined light source, a second light input terminal corresponding and adjacent to the second light-emitting module for receiving the second predetermined light source, a third light input terminal corresponding and adjacent to the third light-emitting module for receiving the third predetermined light source, and a light output terminal, and the first light input terminal, the second light input terminal and the third light input terminal are separated from each other. The prism unit includes at least one polarization beam splitting prism corresponding and adjacent to the light output terminal. The image display unit includes at least one image display panel corresponding and adjacent to one lateral side of the at least one polarization beam splitting prism. The image projection unit includes at least one projection lens corresponding and adjacent to another lateral side of the at least one polarization beam splitting prism. Therefore, the first predetermined light source, the second predetermined light source and the third predetermined light source concurrently pass through the at least one photonic crystal fiber structure to form a mixed surface light source that is projected onto the at least one polarization beam splitting prism from the light output terminal, the surface light source is reflected by the at least one polarization beam splitting prism to form a reflecting light source that is projected onto the at least one image display panel, the reflecting light source is reflected by the at least one image display panel to form an image light source that is projected onto the at least one polarization beam splitting prism, and the image light source sequentially passes through the at least one polarization beam splitting prism and the at least one projection lens to form an image projection light source.

Yet another one of the embodiments of the instant disclosure provides a projection device for increasing light-transmitting efficiency, comprising: a light-emitting unit, a light-guiding unit, an image display module and an image projection unit. The light-emitting unit includes a first light-emitting module for generating a first predetermined light source, a second light-emitting module for generating a second predetermined light source, and a third light-emitting module for generating a third predetermined light source. The light-guiding unit includes at least one photonic crystal fiber structure, wherein the at least one photonic crystal fiber structure has a first light input terminal corresponding and adjacent to the first light-emitting module for receiving the first predetermined light source, a second light input terminal corresponding and adjacent to the second light-emitting module for receiving the second predetermined light source, a third light input terminal corresponding and adjacent to the third light-emitting module for receiving the third predetermined light source, and a light output terminal, and the first light input terminal, the second light input terminal and the third light input terminal are separated from each other. The image display module is corresponding and adjacent to the light output terminal. The image projection unit includes at least one projection lens corresponding and adjacent to the image display module.

More precisely, the at least one photonic crystal fiber structure has a light-mixing section for mixing the first predetermined light source, the second predetermined light source and the third predetermined light source, a first light-guiding section divaricately extended from the light-mixing section to guide the first predetermined light source from the first light-emitting module into the light-mixing section, a second light-guiding section divaricately extended from the light-mixing section to guide the second predetermined light source from the second light-emitting module into the light-mixing section, and a third light-guiding section divaricately extended from the light-mixing section to guide the third predetermined light source from the third light-emitting module into the light-mixing section, the first light input terminal is disposed on an end of the first light-guiding section, the second light input terminal is disposed on an end of the second light-guiding section, the third light input terminal is disposed on an end of the third light-guiding section, and the light output terminal is disposed on an end of the light-mixing section.

Therefore, because the light-guiding unit includes at least one photonic crystal fiber structure disposed between the light-emitting unit and the image display unit or between the light-emitting unit and the prism unit, the light-transmitting efficiency of the projection device of the instant disclosure can be increased (i.e., the optical loss of the projection device of the instant disclosure can be decreased). In addition, the size of the projection device of the instant disclosure can be reduced due to the flexibility of the photonic crystal fiber structure.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a schematic view of the projection device according to the first embodiment of the instant disclosure;

FIG. 2 shows a schematic view of the light-emitting unit and the light-guiding unit cooperated with each other according to the first embodiment of the instant disclosure;

FIG. 3 shows a lateral, schematic view of the light-guiding unit of the projection device according to the first embodiment of the instant disclosure;

FIG. 4 shows a schematic view of the light-emitting unit, the light-condensing unit and the light-guiding unit cooperated with each other according to the first embodiment of the instant disclosure; and

FIG. 5 shows a schematic view of the projection device according to the second embodiment of the instant disclosure.

### DETAILED DESCRIPTION OF THE PREFERRED EMBODIMENTS

### First Embodiment

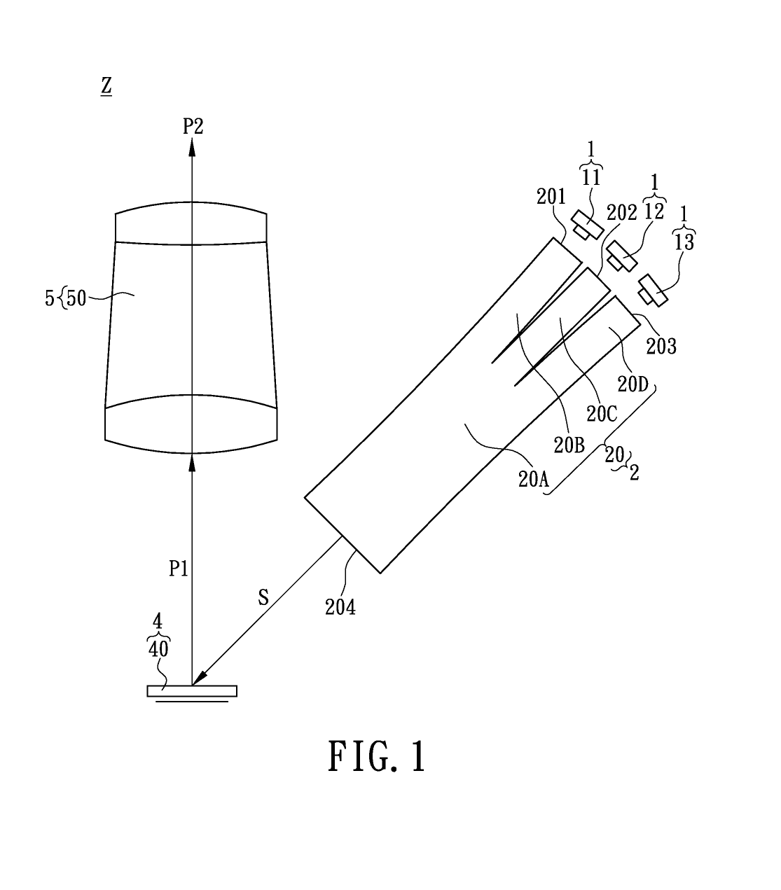

Referring to FIG. 1 to FIG. 4, where the first embodiment of the instant disclosure provides a projection device Z for increasing light-transmitting efficiency comprising: a light-emitting unit 1, a light-guiding unit 2, an image display unit 4 and an image projection unit 5, and the light-guiding unit 2 includes at least one photonic crystal fiber structure 20.

First, referring to FIG. 1 to FIG. 3, the light-emitting unit 1 includes a first light-emitting module 11 for generating a first predetermined light source L1, a second light-emitting module 12 for generating a second predetermined light source L2, and a third light-emitting module 13 for generating a third predetermined light source L3.

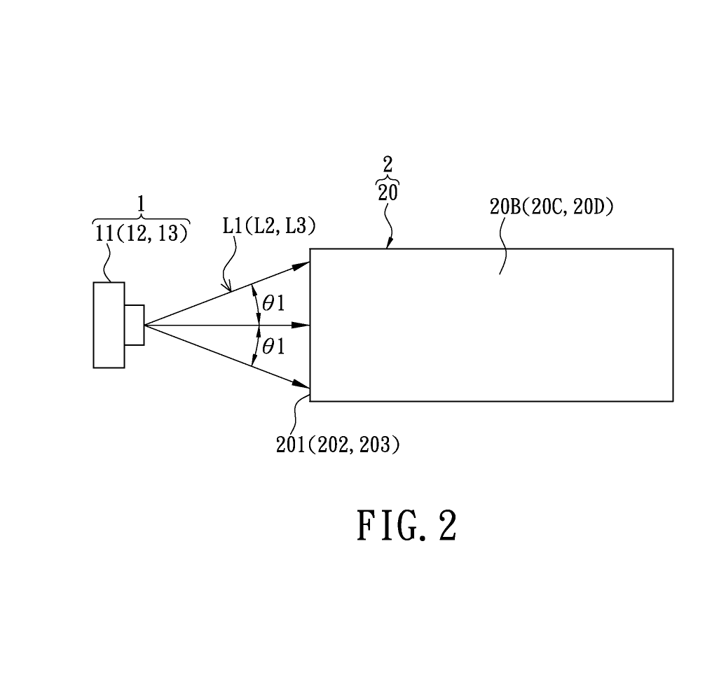

For example, referring to FIG. 1 and FIG. 2, the first light-emitting module 11 may be a red laser diode for generating a red light source, the second light-emitting module 12 may be a green laser diode for generating a green light source, and the third light-emitting module 13 may be a blue laser diode for generating a blue light source. When the first light-emitting module 11, the second light-emitting module 12 and the third light-emitting module 13 are laser diodes, the light-projecting half angles θ1 (θ1≦15°) of the first light-emitting module 11, the second light-emitting module 12 and the third light-emitting module 13 can be equal to or smaller than 15 degrees, thus the light-receiving efficiency of the photonic crystal fiber structure 20 for receiving the first predetermined light source L1, the second predetermined light source L2 and the third predetermined light source L3 can be increased.

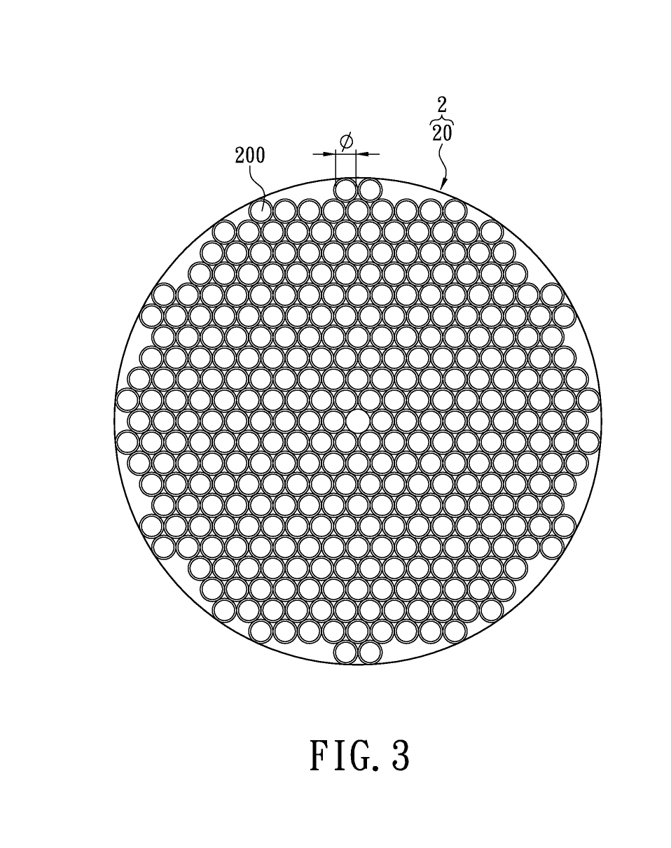

Moreover, referring to FIG. 1 and FIG. 3, the photonic crystal fiber structure 20 has a first light input terminal 201 corresponding and adjacent to the first light-emitting module 11 for receiving the first predetermined light source L1, a second light input terminal 202 corresponding and adjacent to the second light-emitting module 12 for receiving the second predetermined light source L2, a third light input terminal 203 corresponding and adjacent to the third light-emitting module 13 for receiving the third predetermined light source L3, and a light output terminal 204, and the first light input terminal 201, the second light input terminal 202 and the third light input terminal 203 are separated from each other by a predetermined distance. For example, referring to FIG. 3, the photonic crystal fiber structure 20 can be composed of a plurality of fibers 200, and the fibers 200 can be compactly connected with each other by pressing. In addition, each fiber 200 can be made of high purity quartz glass or heat-proof plastic by drawing, and each fiber 200 has an aperture φ (such as a hole diameter) substantially between 0.1 and 10 um (micrometer).

More precisely, referring to FIG. 1, the photonic crystal fiber structure 20 has a light-mixing section 20A (such as a light-blending section) for mixing the first predetermined light source L1, the second predetermined light source L2 and the third predetermined light source L3, a first light-guiding section 20B divaricately extended from the light-mixing section 20A to guide the first predetermined light source L1 from the first light-emitting module 11 into the light-mixing section 20A, a second light-guiding section 20C divaricately extended from the light-mixing section 20A to guide the second predetermined light source L2 from the second light-emitting module 12 into the light-mixing section 20A, and a third light-guiding section 20D divaricately extended from the light-mixing section 20A to guide the third predetermined light source L3 from the third light-emitting module 13 into the light-mixing section 20A. The first light input terminal 201 is disposed on an end of the first light-guiding section 20B, the second light input terminal 202 is disposed on an end of the second light-guiding section 20C, the third light input terminal 203 is disposed on an end of the third light-guiding section 20D, and the light output terminal 204 is disposed on an end of the light-mixing section 20A.

Furthermore, the image display unit 4 (i.e., an image display module) includes at least one image display panel 40 corresponding and adjacent to the light output terminal 204, and the image projection unit 5 includes at least one projection lens 50 corresponding and adjacent to the image display panel 40. For example, the image display panel 40 may be a DLP (digital light processing) or a liquid crystal on silicon (LCOS) panel.

Therefore, the first predetermined light source L1, the second predetermined light source L2 and the third predetermined light source L3 can concurrently pass through the photonic crystal fiber structure 20 to form a mixed surface light source S (such as a rectangular surface light source, and the ratio of length to width is 16:9, 16:10 or 4:3) that can be projected onto the image display panel 40 from the light output terminal 204. The surface light source S can be reflected by the image display panel 40 to form an image light source P1 that can be projected onto the projection lens 50, and the image light source P1 can pass through the projection lens 50 to form an image projection light source P2 that can be projected onto a screen.

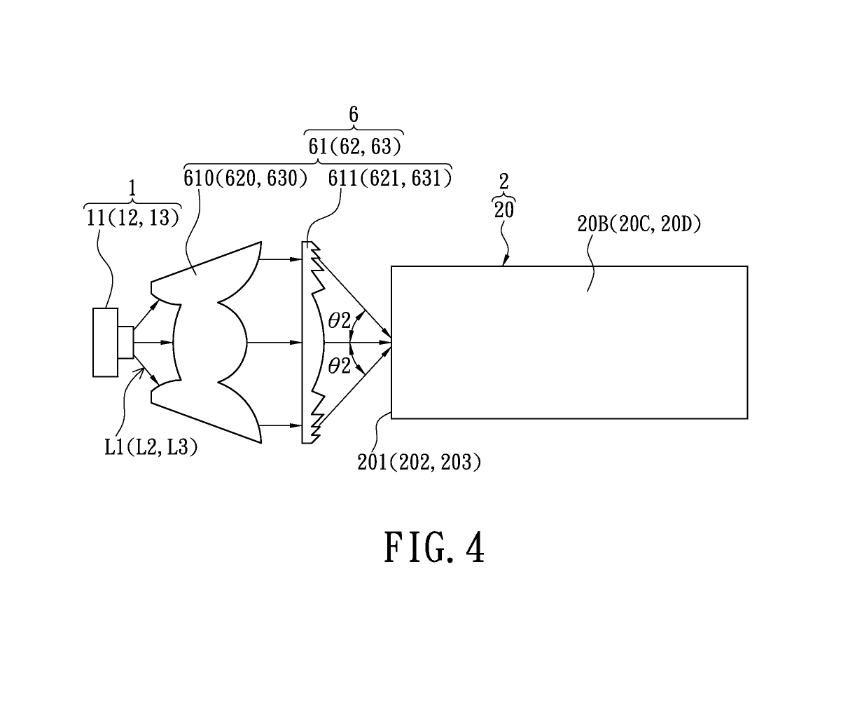

For another example, referring to FIG. 1 and FIG. 4, the first light-emitting module 11 may be a light-emitting diode (LED) for generating a red light source, the second light-emitting module 12 may be a light-emitting diode for generating a green light source, and the third light-emitting module 13 may be a light-emitting diode for generating a blue light source. When the first light-emitting module 11, the second light-emitting module 12 and the third light-emitting module 13 are light-emitting diodes, the projection device Z further comprises a light-condensing unit 6 including a first emission angle adjusting module 61 disposed between the first light-emitting module 11 and the first light input terminal 201 of the photonic crystal fiber structure 20, a second emission angle adjusting module 62 disposed between the second light-emitting module 12 and the second light input terminal 202 of the photonic crystal fiber structure 20, and a third emission angle adjusting module 63 disposed between the third light-emitting module 13 and the third light input terminal 203 of the photonic crystal fiber structure 20. In addition, the first predetermined light source L1 can be projected onto the first light input terminal 201 through the first emission angle adjusting module 61, the second predetermined light source L2 can be projected onto the second light input terminal 202 through the second emission angle adjusting module 62, and the third predetermined light source L3 can be projected onto the third light input terminal 203 through the third emission angle adjusting module 63.

More precisely, the first emission angle adjusting module 61 includes a first light-diverging lens 610 adjacent to the first light-emitting module 11 and a first light-condensing lens 611 disposed between the first light-diverging lens 610 and the first light input terminal 201 of the photonic crystal fiber structure 20. The second emission angle adjusting module 62 includes a second light-diverging lens 620 adjacent to the second light-emitting module 12 and a second light-condensing lens 621 disposed between the second light-diverging lens 620 and the second light input terminal 202 of the photonic crystal fiber structure 20, and the third emission angle adjusting module 63 includes a third light-diverging lens 630 adjacent to the third light-emitting module 13 and a third light-condensing lens 631 disposed between the third light-diverging lens 630 and the third light input terminal 203 of the photonic crystal fiber structure 20. However, the light-condensing unit 6 used in the first embodiment is merely an example and is not meant to limit the instant disclosure.

Hence, the first predetermined light source L1, the second predetermined light source L2 and the third predetermined light source L3 can respectively pass through the first emission angle adjusting module 61, the second emission angle adjusting module 62 and the third emission angle adjusting module 63, thus the incident half angle θ2 of the incident light projected onto the photonic crystal fiber structure 20 can be adjusted to equal to or smaller than 15 degrees (θ2≦15°), thus the light-receiving efficiency of the photonic crystal fiber structure 20 for receiving the incident light can be increased.

### Second Embodiment

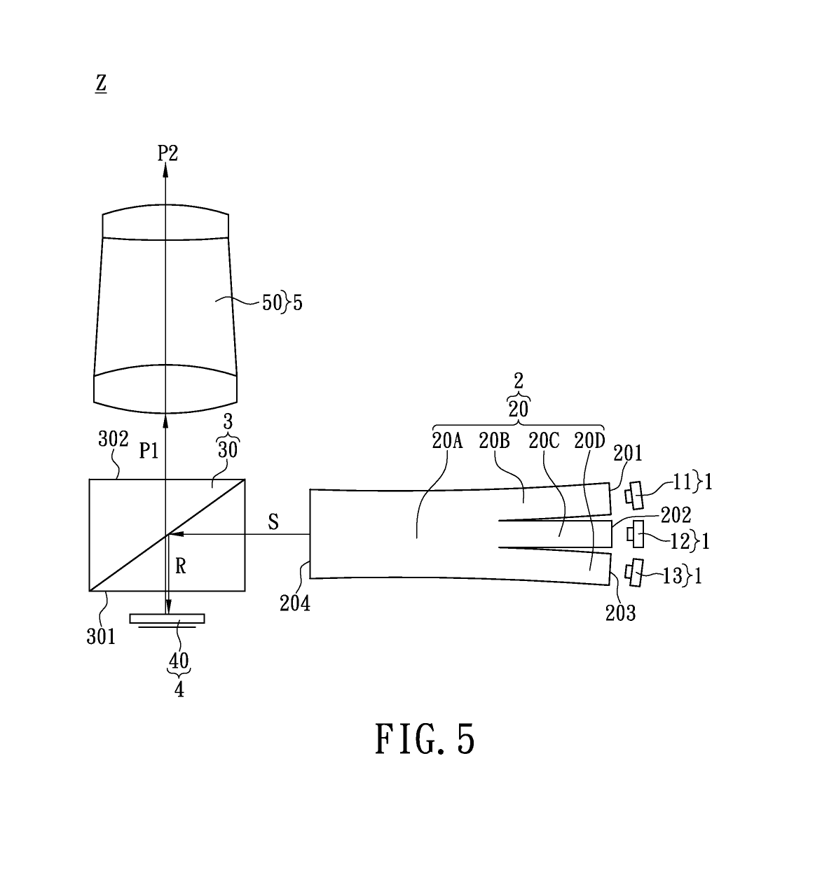

Referring to FIG. 5, where the second embodiment of the instant disclosure provides a projection device Z for increasing light-transmitting efficiency comprising: a light-emitting unit 1, a light-guiding unit 2, a prism unit 3, an image display unit 4 and an image projection unit 5. Comparing FIG. 5 with FIG. 1, the difference between the second embodiment and the first embodiment is as follows: in the second embodiment, the prism unit 3 includes at least one polarization beam splitting prism 30 corresponding and adjacent to the light output terminal 204, the image display unit 4 includes at least one image display panel 40 corresponding and adjacent to one lateral side (such as a first lateral side 301) of the polarization beam splitting prism 30, and the image projection unit 5 includes at least one projection lens 50 corresponding and adjacent to another lateral side (such as a second lateral side 302 opposite to the first lateral side 301) of the polarization beam splitting prism 30, where the prism unit 3 and the image display unit 4 can be combined to form an image display module.

Therefore, the first predetermined light source L1, the second predetermined light source L2 and the third predetermined light source L3 can concurrently pass through the photonic crystal fiber structure 20 to form a mixed surface light source S (such as a rectangular surface light source, and the ratio of length to width is 16:9, 16:10 or 4:3) that can be projected onto the polarization beam splitting prism 30 from the light output terminal 204. The surface light source S can be reflected substantially about 90 degrees by the polarization beam splitting prism 30 to form a reflecting light source R that can be projected onto the image display panel 40, the reflecting light source R can be reflected substantially about 180 degrees by the image display panel 40 to form an image light source P1 that can be projected onto the polarization beam splitting prism 30, and the image light source P1 can be sequentially pass through the polarization beam splitting prism 30 and the projection lens 50 to form an image projection light source P2 projected onto a screen.

In conclusion, because the light-guiding unit 2 includes at least one photonic crystal fiber structure 20 disposed between the light-emitting unit 1 and the image display unit 4 or between the light-emitting unit 1 and the prism unit 3, the light-transmitting efficiency of the projection device Z of the instant disclosure can be increased (i.e., the optical loss of the projection device Z of the instant disclosure can be decreased). In addition, the size of the projection device Z of the instant disclosure can be reduced due to the flexibility of the photonic crystal fiber structure.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A projection device for increasing light-transmitting efficiency, comprising:
a light-emitting unit including a first light-emitting module for generating a first predetermined light source, a second light-emitting module for generating a second predetermined light source, and a third light-emitting module for generating a third predetermined light source;
a light-guiding unit including at least one photonic crystal fiber structure, wherein the at least one photonic crystal fiber structure has a first light input terminal corresponding and adjacent to the first light-emitting module for receiving the first predetermined light source, a second light input terminal corresponding and adjacent to the second light-emitting module for receiving the second predetermined light source, a third light input terminal corresponding and adjacent to the third light-emitting module for receiving the third predetermined light source, and a light output terminal, and the first light input terminal, the second light input terminal and the third light input terminal are separated from each other;
an image display unit including at least one image display panel corresponding and adjacent to the light output terminal; and
an image projection unit including at least one projection lens corresponding and adjacent to the at least one image display panel;
wherein, the first predetermined light source, the second predetermined light source and the third predetermined light source concurrently pass through the at least one photonic crystal fiber structure to form a mixed surface light source that is projected onto the at least one image display panel from the light output terminal, the surface light source is reflected by the at least one image display panel to form an image light source that is projected onto the at least one projection lens, and the image light source passes through the at least one projection lens to form an image projection light source.

2. The projection device of claim 1, wherein the first light-emitting module is a red laser diode for generating a red light source, the second light-emitting module is a green laser diode for generating a green light source, and the third light-emitting module is a blue laser diode for generating a blue light source.

3. The projection device of claim 1, wherein the first light-emitting module is a light-emitting diode for generating a red light source, the second light-emitting module is a light-emitting diode for generating a green light source, and the third light-emitting module is a light-emitting diode for generating a blue light source.

4. The projection device of claim 1, wherein the at least one photonic crystal fiber structure has a light-mixing section for mixing the first predetermined light source, the second predetermined light source and the third predetermined light source, a first light-guiding section divaricately extended from the light-mixing section to guide the first predetermined light source from the first light-emitting module into the light-mixing section, a second light-guiding section divaricately extended from the light-mixing section to guide the second predetermined light source from the second light-emitting module into the light-mixing section, and a third light-guiding section divaricately extended from the light-mixing section to guide the third predetermined light source from the third light-emitting module into the light-mixing section, the first light input terminal is disposed on an end of the first light-guiding section, the second light input terminal is disposed on an end of the second light-guiding section, the third light input terminal is disposed on an end of the third light-guiding section, and the light output terminal is disposed on an end of the light-mixing section.

5. The projection device of claim 1, wherein the at least one photonic crystal fiber structure is composed of a plurality of fibers, and each fiber has an aperture between 0.1 and 10 um.

6. The projection device of claim 1, further comprising: a light-condensing unit including a first emission angle adjusting module disposed between the first light-emitting module and the first light input terminal of the at least one photonic crystal fiber structure, a second emission angle adjusting module disposed between the second light-emitting module and the second light input terminal of the at least one photonic crystal fiber structure, and a third emission angle adjusting module disposed between the third light-emitting module and the third light input terminal of the at least one photonic crystal fiber structure, wherein the first predetermined light source is projected onto the first light input terminal through the first emission angle adjusting module, the second predetermined light source is projected onto the second light input terminal through the second emission angle adjusting module, and the third predetermined light source is projected onto the third light input terminal through the third emission angle adjusting module.

7. The projection device of claim 6, wherein the first emission angle adjusting module includes a first light-diverging lens adjacent to the first light-emitting module and a first light-condensing lens disposed between the first light-diverging lens and the first light input terminal of the at least one photonic crystal fiber structure, the second emission angle adjusting module includes a second light-diverging lens adjacent to the second light-emitting module and a second light-condensing lens disposed between the second light-diverging lens and the second light input terminal of the at least one photonic crystal fiber structure, and the third emission angle adjusting module includes a third light-diverging lens adjacent to the third light-emitting module and a third light-condensing lens disposed between the third light-diverging lens and the third light input terminal of the at least one photonic crystal fiber structure.

8. A projection device for increasing light-transmitting efficiency, comprising:
a light-emitting unit including a first light-emitting module for generating a first predetermined light source, a second light-emitting module for generating a second predetermined light source, and a third light-emitting module for generating a third predetermined light source;
a light-guiding unit including at least one photonic crystal fiber structure, wherein the at least one photonic crystal fiber structure has a first light input terminal corresponding and adjacent to the first light-emitting module for receiving the first predetermined light source, a second light input terminal corresponding and adjacent to the second light-emitting module for receiving the second predetermined light source, a third light input terminal corresponding and adjacent to the third light-emitting module for receiving the third predetermined light source, and a light output terminal, and the first light input terminal, the second light input terminal and the third light input terminal are separated from each other;
a prism unit including at least one polarization beam splitting prism corresponding and adjacent to the light output terminal;
an image display unit including at least one image display panel corresponding and adjacent to one lateral side of the at least one polarization beam splitting prism; and
an image projection unit including at least one projection lens corresponding and adjacent to another lateral side of the at least one polarization beam splitting prism;
wherein, the first predetermined light source, the second predetermined light source and the third predetermined light source concurrently pass through the at least one photonic crystal fiber structure to form a mixed surface light source that is projected onto the at least one polarization beam splitting prism from the light output terminal, the surface light source is reflected by the at least one polarization beam splitting prism to form a reflecting light source that is projected onto the at least one image display panel, the reflecting light source is reflected by the at least one image display panel to form an image light source that is projected onto the at least one polarization beam splitting prism, and the image light source sequentially passes through the at least one polarization beam splitting prism and the at least one projection lens to form an image projection light source.

9. The projection device of claim 8, wherein the first light-emitting module is a red laser diode for generating a red light source, the second light-emitting module is a green laser diode for generating a green light source, and the third light-emitting module is a blue laser diode for generating a blue light source.

10. The projection device of claim 8, wherein the first light-emitting module is a light-emitting diode for generating a red light source, the second light-emitting module is a light-emitting diode for generating a green light source, and the third light-emitting module is a light-emitting diode for generating a blue light source.

11. The projection device of claim 8, wherein the at least one photonic crystal fiber structure has a light-mixing section for mixing the first predetermined light source, the second predetermined light source and the third predetermined light source, a first light-guiding section divaricately extended from the light-mixing section to guide the first predetermined light source from the first light-emitting module into the light-mixing section, a second light-guiding section divaricately extended from the light-mixing section to guide the second predetermined light source from the second light-emitting module into the light-mixing section, and a third light-guiding section divaricately extended from the light-mixing section to guide the third predetermined light source from the third light-emitting module into the light-mixing section, the first light input terminal is disposed on an end of the first light-guiding section, the second light input terminal is disposed on an end of the second light-guiding section, the third light input terminal is disposed on an end of the third light-guiding section, and the light output terminal is disposed on an end of the light-mixing section.

12. The projection device of claim 8, wherein the at least one photonic crystal fiber structure is composed of a plurality of fibers, and each fiber has an aperture between 0.1 and 10 um.

13. The projection device of claim 8, further comprising: a light-condensing unit including a first emission angle adjusting module disposed between the first light-emitting module and the first light input terminal of the at least one photonic crystal fiber structure, a second emission angle adjusting module disposed between the second light-emitting module and the second light input terminal of the at least one photonic crystal fiber structure, and a third emission angle adjusting module disposed between the third light-emitting module and the third light input terminal of the at least one photonic crystal fiber structure, wherein the first predetermined light source is projected onto the first light input terminal through the first emission angle adjusting module, the second predetermined light source is projected onto the second light input terminal through the second emission angle adjusting module, and the third predetermined light source is projected onto the third light input terminal through the third emission angle adjusting module.

14. The projection device of claim 13, wherein the first emission angle adjusting module includes a first light-diverging lens adjacent to the first light-emitting module and a first light-condensing lens disposed between the first light-diverging lens and the first light input terminal of the at least one photonic crystal fiber structure, the second emission angle adjusting module includes a second light-diverging lens adjacent to the second light-emitting module and a second light-condensing lens disposed between the second light-diverging lens and the second light input terminal of the at least one photonic crystal fiber structure, and the third emission angle adjusting module includes a third light-diverging lens adjacent to the third light-emitting module and a third light-condensing lens disposed between the third light-diverging lens and the third light input terminal of the at least one photonic crystal fiber structure.

15. A projection device for increasing light-transmitting efficiency, comprising:
a light-emitting unit including a first light-emitting module for generating a first predetermined light source, a second light-emitting module for generating a second predetermined light source, and a third light-emitting module for generating a third predetermined light source;
a light-guiding unit including at least one photonic crystal fiber structure, wherein the at least one photonic crystal fiber structure has a first light input terminal corresponding and adjacent to the first light-emitting module for receiving the first predetermined light source, a second light input terminal corresponding and adjacent to the second light-emitting module for receiving the second predetermined light source, a third light input terminal corresponding and adjacent to the third light-emitting module for receiving the third predetermined light source, and a light output terminal, and the first light input terminal, the second light input terminal and the third light input terminal are separated from each other;
an image display module corresponding and adjacent to the light output terminal; and
an image projection unit including at least one projection lens corresponding and adjacent to the image display module.

16. The projection device of claim 15, wherein the image display module comprise an image display unit including at least one image display panel corresponding and adjacent to the light output terminal, and the at least one projection lens is corresponding and adjacent to the at least one image display panel.

17. The projection device of claim 15, wherein the image display module comprises:
a prism unit including at least one polarization beam splitting prism corresponding and adjacent to the light output terminal; and
an image display unit including at least one image display panel corresponding and adjacent to one lateral side of the at least one polarization beam splitting prism, wherein the at least one projection lens is corresponding and adjacent to another lateral side of the at least one polarization beam splitting prism.

18. The projection device of claim 15, wherein the at least one photonic crystal fiber structure has a light-mixing section for mixing the first predetermined light source, the second predetermined light source and the third predetermined light source, a first light-guiding section divaricately extended from the light-mixing section to guide the first predetermined light source from the first light-emitting module into the light-mixing section, a second light-guiding section divaricately extended from the light-mixing section to guide the second predetermined light source from the second light-emitting module into the light-mixing section, and a third light-guiding section divaricately extended from the light-mixing section to guide the third predetermined light source from the third light-emitting module into the light-mixing section, the first light input terminal is disposed on an end of the first light-guiding section, the second light input terminal is disposed on an end of the second light-guiding section, the third light input terminal is disposed on an end of the third light-guiding section, and the light output terminal is disposed on an end of the light-mixing section.

19. The projection device of claim 15, wherein the at least one photonic crystal fiber structure is composed of a plurality of fibers, and each fiber has an aperture between 0.1 and 10 um.

20. The projection device of claim 15, further comprising: a light-condensing unit including a first emission angle adjusting module disposed between the first light-emitting module and the first light input terminal of the at least one photonic crystal fiber structure, a second emission angle adjusting module disposed between the second light-emitting module and the second light input terminal of the at least one photonic crystal fiber structure, and a third emission angle adjusting module disposed between the third light-emitting module and the third light input terminal of the at least one photonic crystal fiber structure, wherein the first predetermined light source is projected onto the first light input terminal through the first emission angle adjusting module, the second predetermined light source is projected onto the second light input terminal through the second emission angle adjusting module, and the third predetermined light source is projected onto the third light input terminal through the third emission angle adjusting module, wherein the first emission angle adjusting module includes a first light-diverging lens adjacent to the first light-emitting module and a first light-condensing lens disposed between the first light-diverging lens and the first light input terminal of the at least one photonic crystal fiber structure, the second emission angle adjusting module includes a second light-diverging lens adjacent to the second light-emitting module and a second light-condensing lens disposed between the second light-diverging lens and the second light input terminal of the at least one photonic crystal fiber structure, and the third emission angle adjusting module includes a third light-diverging lens adjacent to the third light-emitting module and a third light-condensing lens disposed between the third light-diverging lens and the third light input terminal of the at least one photonic crystal fiber structure.
